(19) United States
(12) Patent Application Publication
(10) Pub. No.: US 2008/0211981 A1
(43) Pub. Date: Sep. 4, 2008

(54) DISPLAY DEVICE

(76) Inventors: Daisuke Sonoda, Chiba (JP); Toshiki Kaneko, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/946,954

(22) Filed: Nov. 29, 2007

(30) Foreign Application Priority Data
Dec. 1, 2006 (JP) 2006-325116

(51) Int. Cl. G02F 1/136

(52) U.S. Cl. 349/46

(57) ABSTRACT

The present invention relates to a technique for preventing the occurrence of a contact defect or exfoliation caused by a Mo oxide layer that is produced on a surface of a conductive layer when a coating type insulating film is applied onto a conductive layer made of a Mo or Mo-alloy. A display device (e.g., a liquid crystal display device) of the present invention has a first substrate, wherein the first substrate includes a first conductive layer composed of a Mo or Mo-alloy layer, a coating type insulating film formed above the first conductive layer, and a second conductive layer composed of an Al or Al-alloy layer (or Ti or Ti-alloy layer) formed on the conductive layer and wherein the coating type insulating film is formed on the second conductive layer.

### CLAIM OF PRIORITY

The present application claims priority from Japanese Application JP 2006-325116 filed on Dec. 1, 2006, the content of which is hereby incorporated by reference into this application.

### BACKGROUND OF THE INVENTION

1. Field of the Invention

The present invention relates to a display device, more specifically, to a technique effective in application to a substrate having an active element (e.g., a thin film transistor) of a liquid display panel formed thereon.

2. Description of the Related Arts

In general, an active matrix type liquid crystal display panel generates an electric field between a pixel electrode of each sub-pixel and a counter electrode, drives liquid crystal cells by the electric field, and modulates light passing through a liquid crystal layer to display an image. For instance, a liquid crystal display panel of an IPS type (also called a horizontal electric field applying type) generates an electric field parallel to a substrate at least in a part of the region between a pixel electrode and a counter electrode, drives liquid crystal cells by the electrode, and modulates light passing through a liquid crystal layer, to display an image.

In this case, an active element functioning as a switching element for applying a gradation voltage to a pixel electrode is formed on one of a substrate pair sandwiching liquid crystals This active element is formed under the pixel electrode with an interlayer insulating film interposed in between, and is connected to the pixel electrode via a contact hole formed in the interlayer insulating film.

A driving circuit (also called a driver) for driving each sub-pixel is also arranged outside a display area where each sub-pixel is formed. In some cases, this driving circuit and an active element functioning as a switching element are formed in one unit on one of the substrates.

A coating type insulating film made of polysilazanes or polysiloxanes for example may be used for the lamination of wiring of an active matrix-type liquid crystal display panel on a large-area glass substrate.

As shown in FIG. 11, however, if a coating type insulating film 20 is applied onto a Mo or Mo-alloy (Mo-GT) used as a conventional gate electrode material, a Mo oxide layer (Mo-OXD) is formed on the surface of a gate electrode by water that is produced by polycondensation of the coating type insulating film 20. Therefore, as shown in FIG. 12, contact defects may occur when the Mo or Mo-alloy (Mo-GT) forming the gate electrode is connected to a metal wiring (MDS), or as shown in FIG. 13, film exfoliation (KUD) may be caused. In FIGS. 11 through 13, SUB1 is a glass substrate, SGI is a buried insulating film, p-Si is a semiconductor layer, GI is a gate insulating film, SD1 is a source electrode, and SD2 is a drain electrode.

### SUMMARY OF THE INVENTION

In view of problems in the related art technique, it is, therefore, an object of the present invention to provide a technique for preventing the occurrence of a contact defect or exfoliation caused by a Mo oxide layer that is produced on a surface of a conductive layer when a coating type insulating film is applied onto a conductive layer made of a Mo or Mo-alloy.

(1) To achieve the above object, there is provided a display device (e.g., a liquid crystal display device) including a first substrate, wherein the first substrate has a first conductive layer composed of a Mo or Mo-alloy layer, a coating type insulating film formed above the first conductive layer, and a second conductive layer composed of an Al or Al-alloy layer formed on the conductive layer and wherein the coating type insulating film is formed on the second conductive layer.

(2) Another aspect of the present invention provides a display device (e.g., a liquid crystal display device) including a first substrate, wherein the first substrate has a first conductive layer composed of a Mo or Mo-alloy layer, a coating type insulating film formed above the first conductive layer, and a second conductive layer composed of a Ti or Ti-alloy layer formed on the conductive layer and wherein the coating type insulating film is formed on the second conductive layer.

(3) In (1) or (2), the first conductive layer and the second conductive layer are transistor gate electrodes, and the second conductive layer is connected to a wiring layer formed on an upper layer of the coating type insulating film.

(4) In the transistor of (3), a low concentration impurity region having the concentration of introduced impurities lower than that of a drain region and a source region is formed in a portion of at least one of the drain and source regions adjacent to a channel region. The first conductive layer is formed on the channel region and the low concentration impurity region of the transistor, and the second conductive layer is formed on the first conductive layer, that is, above the channel region of the transistor.

(5) In (1) or (2), the first conductive layer and the second conductive layer are wiring layers.

(6) There is provided a display device (e.g., a liquid crystal display device) including a first substrate, wherein the first substrate has a first conductive layer composed of a Mo or Mo-alloy layer, a coating type insulating film formed above the first conductive layer, and a Mo nitride film formed on the first conductive layer, and wherein the coating type insulating film is formed on the Mo nitride film.

(7) In (6), the first conductive layer is a transistor gate electrode or a wiring layer.

(8) In any of (1) through (7), the coating type insulating film is composed of a polysilazane or a polysiloxane.

To be short, one representative embodiment of the present invention has the following advantages.

According to the display device of the present invention, it becomes possible to prevent the occurrence of a contact defect or exfoliation caused by a Mo oxide layer that is produced on a surface of a conductive layer when a coating type insulating film is applied onto a conductive layer made of a Mo or Mo-alloy.

### BRIEF DESCRIPTION OF THE DRAWINGS

The above objects, features and advantages of the present invention will become more apparent from the following detailed description when taken in conjunction with the accompanying drawings, in which:

FIG. 1 is a cross-sectional view illustrating a major part of the configuration of one example of a thin film transistor used for a liquid crystal display device according to one embodiment of the present invention;

FIG. 2 is a diagram for explaining that no contact defect occurs in the thin film transistor shown in FIG. 1;

FIG. 3 is a cross-sectional view illustrating a major part of the configuration of another example of a thin film transistor used for a liquid crystal display device according to one embodiment of the present invention;

FIG. 4 is a diagram for explaining that no contact defect occurs in the thin film transistor shown in FIG. 3;

FIGS. 5A to 5F are diagrams for explaining a fabrication method of a thin film transistor shown in FIG. 3;

FIGS. 6A to 6C are cross-sectional views illustrating a major part of the configuration of yet another example of a thin film transistor used for a liquid crystal display device according to one embodiment of the present invention;

FIG. 7 is a plan view showing the configuration of a sub-pixel of a liquid display panel according to one embodiment of the present invention;

FIG. 8 is a cross-sectional view showing a sectional configuration taken along line A-A′ of FIG. 7;

FIG. 9 is a cross-sectional view showing a sectional configuration on a glass substrate (SUB1) side, taken along line B-B′ of FIG. 7;

FIG. 10 shows a driving circuit of a liquid display panel according to one embodiment of the present invention;

FIG. 11 is a drawing for explaining that a Mo oxide layer (Mo-OXD) is formed when a coating type insulating film is applied onto a Mo or Mo-alloy layer;

FIG. 12 is a drawing for explaining a contact defect caused by a Mo oxide layer (Mo-OXD) formed on the surface of a Mo or Mo-alloy layer; and

FIG. 13 is a drawing for explaining exfoliation caused by a Mo oxide layer (Mo-OXD) formed on the surface of a Mo or Mo-alloy layer.

### DETAILED DESCRIPTION OF THE PREFERRED EMBODIMENT

A preferred embodiment of the present invention will now be described with reference to the accompanying drawings.

In the following description, the same drawing reference numerals are used for the same elements even in different drawings, and repetition is omitted.

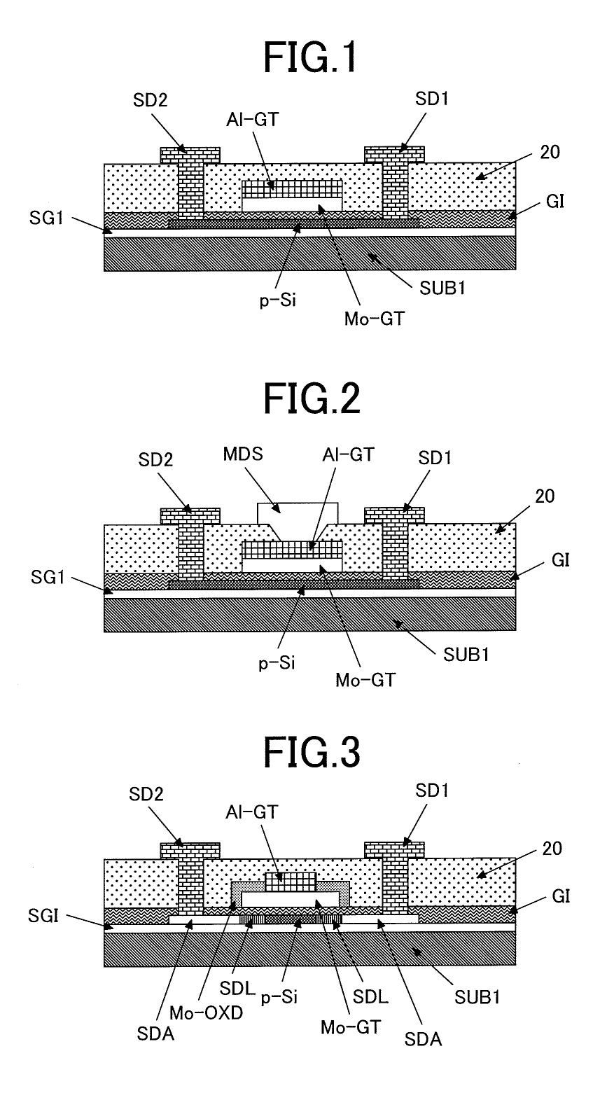

FIG. 1 is a cross-sectional view illustrating a major part of the configuration of one example of a thin film transistor used for a liquid crystal display device according to one embodiment of the present invention.

In FIG. 1, SUB1 is a glass substrate (insulating substrate) forming a substrate on either side. In this embodiment, a buried insulating film SG1, a semiconductor layer p-Si, and a gate insulating film GI are sequentially formed on the glass substrate SUB1. Here, the semiconductor layer is composed of amorphous silicon or polysilicon.

Next, a gate electrode is laminated on the gate insulating film GI and above a channel region of the semiconductor layer p-Si, a coating type insulating film 20 is laminated, and a contact hole is formed by opening the coating type insulating film 20 and portions corresponding to a source region and a drain region of the semiconductor layer p-Si of the gate insulating film GI, respectively. Thereafter, a source region SD1 and a drain region SD2, which are connected to the source region and the drain region of the semiconductor layer p-Si via the contact holes, are formed on the coating type insulating film 20.

Here, the coating type insulating film 20 is composed of a polysilazane or a polysiloxane. Also, lamination of wiring becomes easier because the coating type insulating film 20 can be planarized.

The gate electrode is composed of a Mo or Mo-alloy Mo-GT, or an Al or Al-alloy Al-GT formed on the Mo or Mo-alloy Mo-GT.

Particularly, in a thin film transistor shown in FIG. 1, the gate electrode has a two-layer structure of Al or Al-alloy Al-GT/Mo or Mo-alloy Mo-GT. Therefore, as Mo is capped with Al, it is possible to prevent the formation of a Mo oxide layer Mo-OXD on the surface of the gate electrode due to water produced by polycondensation of the coating type insulating film 20. Examples of the Mo alloy include, but are not limited to, MoW, MoCr etc.

Thus, as shown in FIG. 2, adhesion between the Al or Al-alloy Al-GT and the coating type insulating film 20 is increased, and the contact between the Al or Al-alloy Al-GT and the metal wiring MDS becomes improved. As a result, contact defects similar to ones found in the related art do not occur any more, and/or exfoliation KUD does not occur, either.

Japanese Unexamined Patent Application Publication No. 2000-243834 mentioned earlier discloses the formation of an interlayer insulating film 22 in use of a polysilazane coating type insulating film. However, materials for the gate electrode according to Japanese Unexamined Patent Application Publication No. 2000-243834 include Ti for a lower side and Al for an upper side. In addition, Japanese Unexamined Patent Application Publication No. 2000-243834 does not include Mo as a material for a gate electrode, and obviously it does not have the same object(s) as the present invention.

Similarly, Japanese Unexamined Patent Application Publication No. 2005-93700 mentioned earlier also discloses the formation of an interlayer insulating film 22 in use of a polysilazane coating type insulating film. However, Japanese Unexamined Patent Application Publication No. 2005-93700 does not mention any materials for a gate electrode and does not have the same object(s) as the present invention.

Meanwhile, Japanese Unexamined Patent Application Publication No. 8-116065 mentioned earlier disclosed a gate electrode in a two-layer structure, in which a lower metal layer 6 is mainly composed of Ti, Ni, Mo, W, or Cr as an active element, and an upper metal layer 7 is mainly composed of Al as an active element. However, Japanese Unexamined Patent Application Publication No. 8-116065 does not mention polysilazanes, etc., and does not have the same object(s) as the present invention.

FIG. 3 is a cross-sectional view illustrating a major part of the configuration of another example of a thin film transistor used for a liquid crystal display device according to one embodiment of the present invention.

A gate electrode in the thin film transistor shown in FIG. 3 employs a GOLDD (Gate Overlapped Lightly Doped Drain) structure.

That is, the gate electrode in the thin film transistor shown in FIG. 3 has a two-layer structure of Al or Al-alloy Al-GT/Mo or Mo-alloy MO-GT, wherein the Al or Al-alloy Al-GT of the upper layer is formed only of an upper portion of a channel region of a semiconductor layer p-Si, while the Mo or Mo-alloy MO-GT of the lower layer is formed on a source region and a drain region SDA of the semiconductor layer p-Si, a low concentration impurity region SDL having an impurity concentration of introduced impurities lower than that of the source and the drain region, and a channel region.

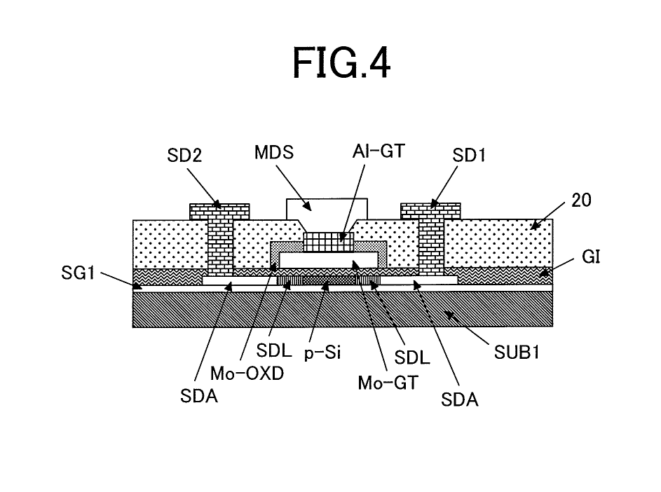

FIG. 4 illustrates a contact state between the gate electrode in the thin film transistor shown in FIG. 3 and a metal wiring MDS. Since the gate electrode also maintains a good contact state with the metal wiring MDS in the embodiment shown in FIG. 3, contact defects similar to ones found in the related art do not occur.

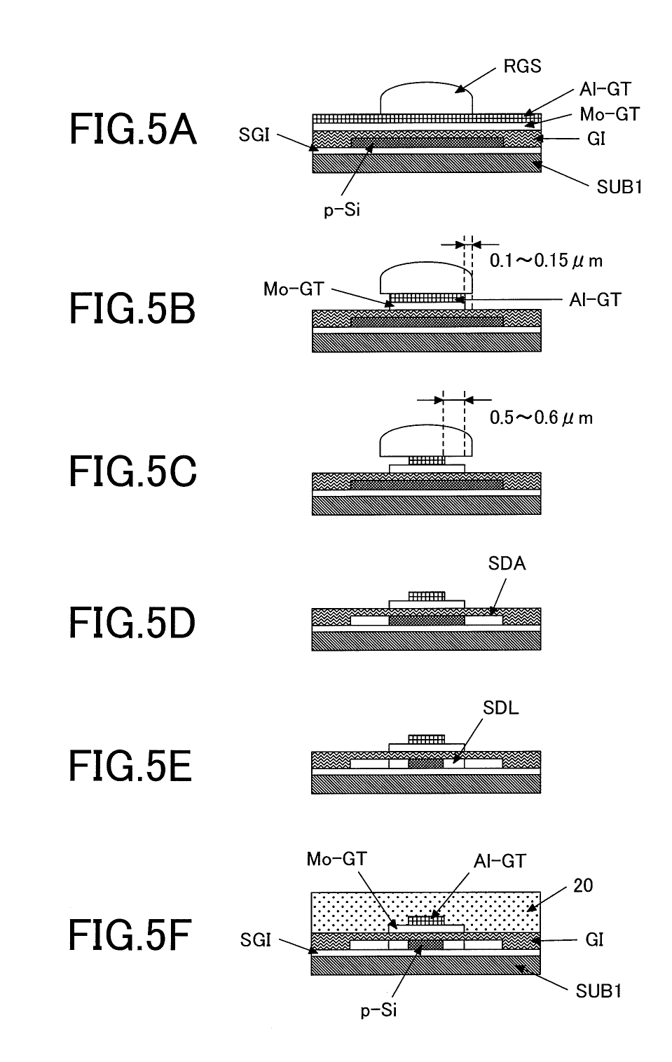

FIG. 5 is a diagram for explaining a fabrication method of the thin film transistor shown in FIG. 3. With reference to FIG. 5, the following will explain a fabrication method, particularly for the thin film transistor of FIG. 3.

First, a buried insulating film SGI, a semiconductor layer p-Si, and a gate insulating film GI are sequentially formed on a glass substrate SUB1.

Next, as shown in FIG. 5A, an Al or Al-alloy Al-GT as an upper layer and a Mo or Mo-alloy Mo-GT as a lower layer are formed by sputtering on the gate insulating film GI. A resist RGS is then formed and patterned by photolithography. Preferably, the Mo or Mo-alloy Mo-GT is 30 to 50 nm in thickness, and the Al or Al-alloy Al-GT is 100 to 150 nm in thickness.

Next, as shown in FIG. 5B, the Al or Al-alloy Al-GT/Mo or Mo-alloy Mo-GT layers are processed en bloc by a mixture of phosphoric acid, nitric acid, and acetic acid, so that the layers sit underneath the resist RGS, being 0.1 to 0.15 μm inwards from both ends of the resist.

Next, as shown in FIG. 5C, each side of the Al or Al-alloy Al-GT layer only is etched as much as 0.5 to 0.6 μm by hydrofluoric acid so that the Al or Al-alloy Al-GT layer is formed only above the channel region of the semiconductor layer p-Si.

Next, as shown in FIG. 5D, the resist RGS is moved and impurities are introduced to the source and drain regions SDA of the semiconductor layer p-Si.

Next, as shown in FIG. 5E, impurities of low concentration are introduced under a portion of the Mo or Mo-alloy Mo-GT layer not being covered with the Al or Al-alloy Al-GT layer. In this manner, a low concentration impurity region SDL is formed among the source and drain regions SDA of the semiconductor layer p-Si, the SDL having the concentration of introduced impurities lower than that of the source and the drain region SDA.

Finally, as shown in FIG. 5F, a coating type insulating film 20 is formed.

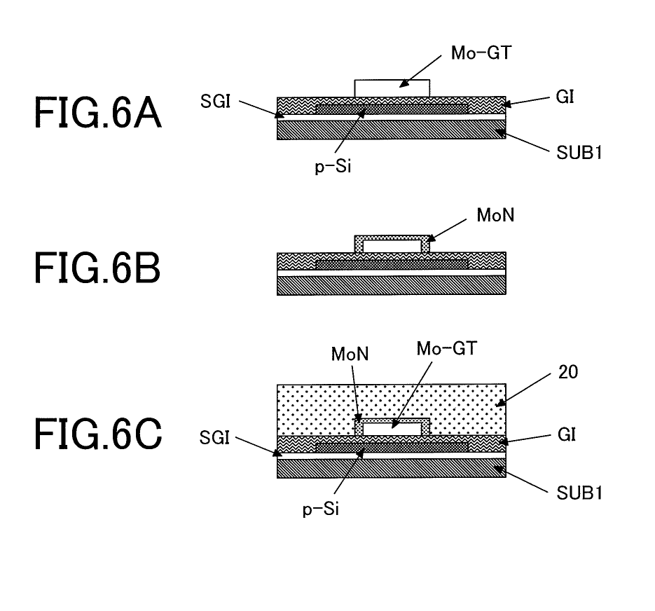

FIGS. 6A to 6C are cross-sectional views illustrating a major part of the configuration of yet another example of a thin film transistor used for a liquid crystal display device according to one embodiment of the present invention.

As shown in FIG. 6C, the thin film transistor of FIGS. 6A to 6C is characterized in that the surface of a gate electrode composed of Mo or Mo-alloy Mo-GT is subjected to a plasma nitriding process to form a Mo nitride layer MoN in order to prevent the formation of a Mo oxide layer Mo-OXD on the surface of the gate electrode due to water having been produced by polycondensation of a coating type insulating film 20.

The following now explains a fabrication method of the thin film transistor shown in FIGS. 6A to 6C.

First, as shown in FIG. 6A, a buried insulating film SGI, a semiconductor layer p-Si, and a gate insulating film GI are sequentially formed on a glass substrate SUB1. After that, a single-layered gate electrode composed of Mo or Mo-alloy Mo-GT is formed on the gate insulating film GI.

Next, as shown in FIG. 6B, a plasma nitriding process is carried out on the surface of the Mo or Mo-alloy Mo-GT to form a Mo nitride layer MoN.

Finally, as shown in FIG. 6C, a coating type insulating film 20 is formed.

The embodiments of the present invention that have been provided so far describe the prevention of the formation of a Mo oxide layer Mo-OXD on the surface of a gate electrode when a coating type insulating film 20 is formed on the gate electrode composed of Mo or Mo-alloy Mo-GT. However, it is needless to say that the present invention is not limited thereto but can also be applied to the prevention of the formation of a Mo oxide layer Mo-OXD on the surface of a wiring layer when a coating type insulating film 20 is formed on the wiring layer composed of Mo or Mo-alloy Mo-GT.

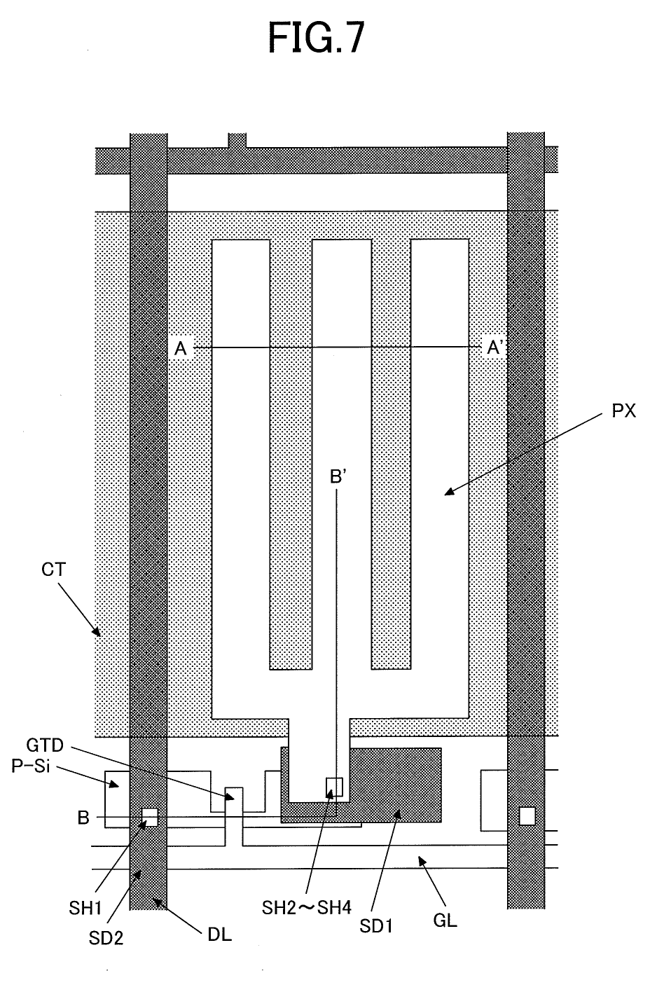

FIG. 7 is a plan view showing the configuration of a sub-pixel of a liquid display panel according to one embodiment of the present invention.

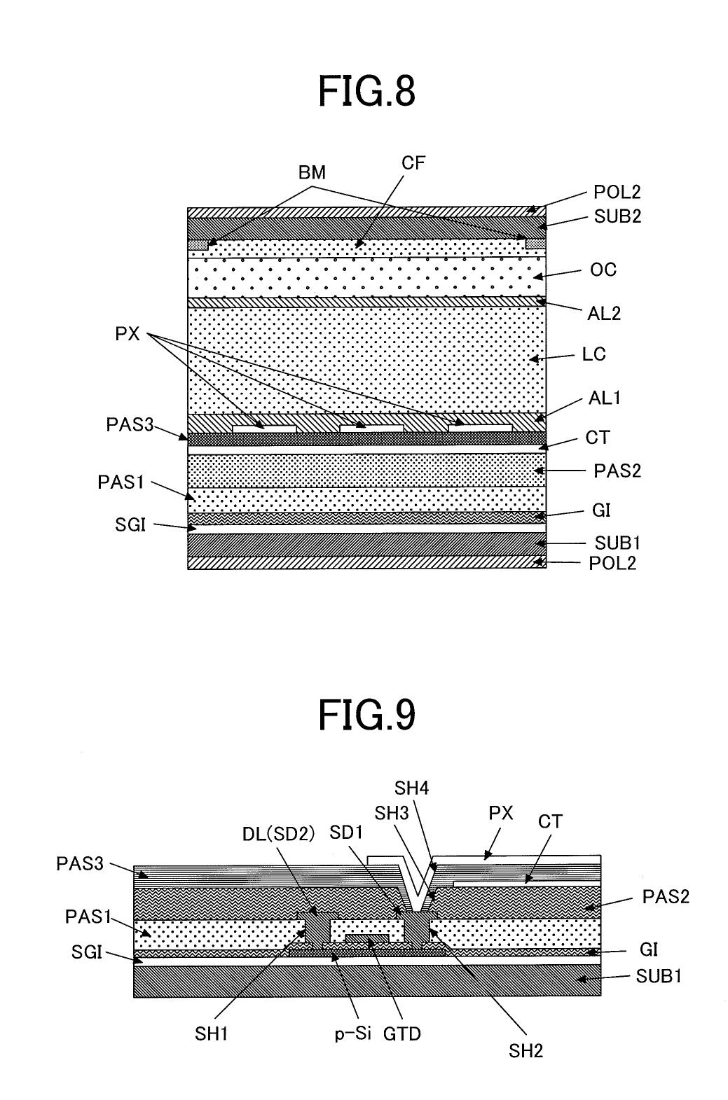

FIG. 8 is a cross-sectional view showing a sectional configuration taken along line A-A′ of FIG. 7. With reference to FIG. 8, the following now explains the configuration of a liquid display panel according this embodiment.

The liquid display panel of this embodiment is an IPS liquid crystal display using a counter electrode of planar shape. As shown in FIG. 8, it has a glass substrate SUB1 and a glass substrate SUB2 as insulating substrates which are arranged to face each other having a liquid crystal layer LC interposed in between. In this embodiment, a main surface side of the glass substrate SUB 2 is observed.

Seen from the glass substrate SUB2 toward the liquid crystal layer LC, a light shielding layer BM, a color filter layer CF, an over-coating layer OC, and an alignment layer AL2 are formed in order. In addition, a polarizer POL2 is arranged outside the glass substrate SUB2.

Seen from the glass substrate SUB1 toward the liquid crystal layer LC, a buried insulating film SGI, a gate insulating film GI, first and second interlayer insulating films PAS1 and PAS2, a counter electrode CT, an interlayer insulating film PAS3, a pixel electrode PX, and alignment layer AL1 are formed in order. In addition, a polarizer POL1 is arranged outside the glass substrate SUB1.

Going back to FIG. 7, DL denotes a video line (also called a drain line and a source line), GL denotes a scan line (also called a gate line), SH1 through SH4 denote through-holes (also called contact holes), GTD denotes a gate electrode, P-Si denotes a semiconductor layer, SD1 denotes a source electrode (also called a drain electrode in the case that a video line DL is referred to as a source line), and SD2 denotes a drain electrode (also called a source electrode in the case that a video line DL is referred to as a source line).

FIG. 9 is a cross-sectional view showing a sectional configuration on the glass substrate SUB1 side, taken along line B-B′ of FIG. 7. In the interest of brevity, the polarizer POL1 is omitted from FIG. 9.

As shown in FIG. 9, on the glass substrate SUB1, the buried insulating film SG1, a laminated film composed of SiN and SiO for example, and the semiconductor layer p-Si are formed. Here, the semiconductor layer p-Si is composed of an amorphous silicon film or a polysilazane film. Next, the gate insulating film GI composed of SiO for example is formed on the semiconductor layer p-Si, and the gate electrode GTD is formed on the gate insulating film GI.

Thereafter, the first interlayer insulating film PAS1 is formed on the gate electrode GTD, and the video line DL used as the drain electrode SD2 and the source electrode SD1 are formed on the first interlayer insulating film PAS1.

A drain region of the semiconductor layer p-Si is connected to the video line DL via the through-hole SH1, and a source region of the semiconductor layer p-Si is connected to the source electrode SD1 via the through-hole SH2.

In addition, the second interlayer insulating film PAS2 is formed on the video line DL and the source electrode SD1, and the counter electrode CT is formed on the second interlayer insulating film PAS2. Moreover, the third interlayer insulating film PAS3 is formed on the counter electrode CT, and the pixel electrode PX is formed on the third interlayer insulating film PAS3.

Here, on the source electrode SD1, the through-hole SH3 is formed in the second interlayer insulating film PAS2, and the third interlayer insulating film PAS3 is formed inside the through-hole SH3. And, the through-hole SH4 is formed in the third interlayer insulating film PAS3 that is formed on the inside of the through-hole SH3. The pixel electrode PX and the source electrode SD1 are electrically connected to each other by a transparent conductive film (e.g., ITO: Indium-Tin-Oxide) formed on the inside of the through-hole SH4. In this manner, the pixel electrode PX is electrically connected to an active element formed at a sub-pixel.

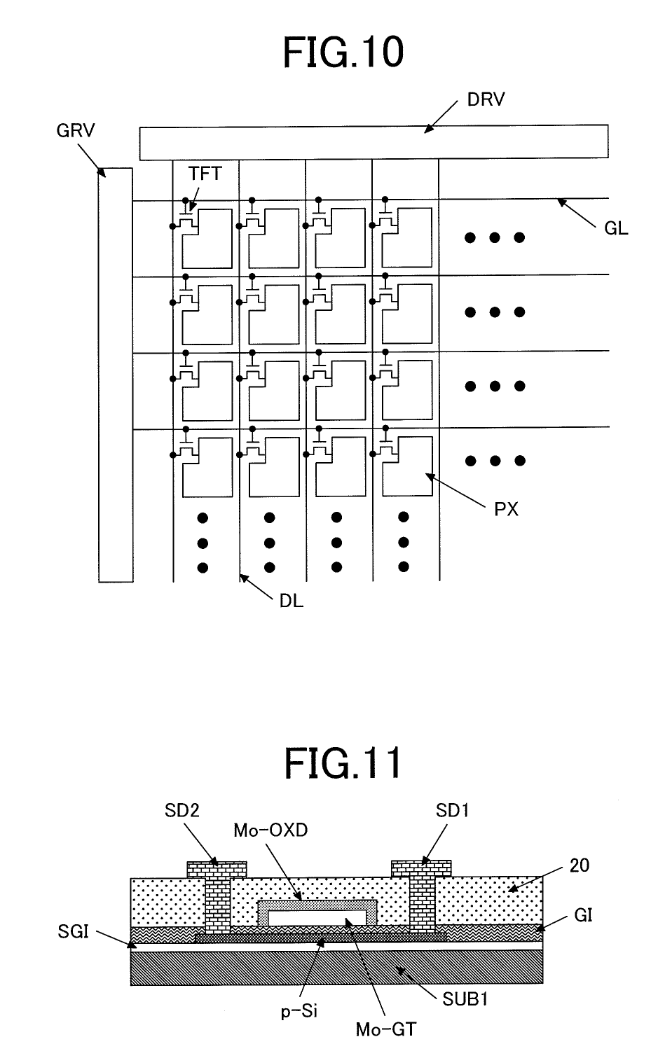

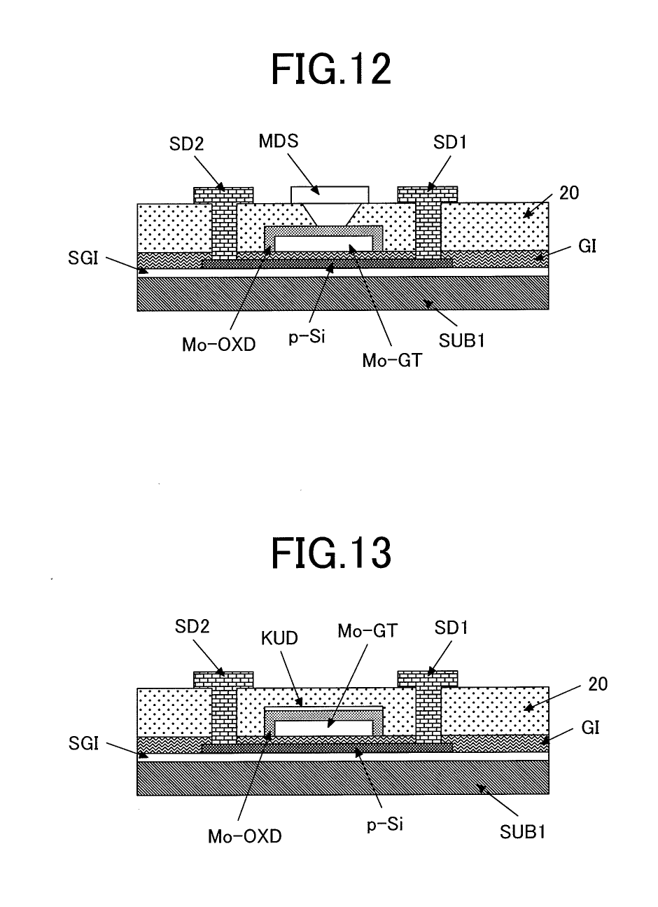

FIG. 10 shows a driving circuit of a liquid display panel according to one embodiment of the present invention. In FIG. 10, TFT (thin film transistor) denotes an active element provided to each sub-pixel, DRV denotes a video line driving circuit, and GRV denotes a scan line driving circuit. The scan line driving circuit GRV and the video line driving circuit DRV are formed outside a display region where each sub-pixel is formed.

The scan line driving circuit GRV sequentially outputs a selection scan voltage for turning on the active element TFT for a predetermined time within one frame to the scan line GL per display line. The video line driving circuit DRV outputs a predetermined gradation voltage to the video line DL when the active element TFT is turned on.

Therefore, an image signal from the video line DL is written into the pixel electrode PX through the active element TFT having been turned on as the selection scan voltage is applied to the scan line GL, and an image is displayed on the liquid crystal display panel.

Here, the scan line driving circuit GRV and the video line driving circuit DRV may be configured by a semiconductor chip, or may be combined with the active element TFT functioning as a switching element on the glass substrate SUB1.

As discussed earlier referring to FIGS. 1 through 7, the conductive film for preventing the formation of a Mo oxide layer Mo-OXD on the surface is a gate electrode or a wiring layer. In this case, if the conductive film is a gate electrode of the active element TFT provided to each sub-pixel, the first interlayer insulating film PAS1 becomes a coating type insulating film.

In the case that the scan line driving circuit GRV and the video line driving circuit DRV shown in FIG. 10 are combined with the active element TFT functioning as a switching element on the glass substrate SUB1 as one unit, the conductive film aforementioned is applied to the gate electrode and the wiring layer of the transistor in the scan line driving circuit GRV and the video line driving circuit DRV shown in FIG. 10.

Moreover, the metal wiring MDS explained in FIGS. 2 and 4 is one of wiring layers used for the scan line driving circuit GRV or the video line driving circuit DRV.

Even though the embodiments provided so far suggested the use of a Mo or Mo-alloy Mo-GT and/or an Al or Al-alloy Al-GT, a Ti or Ti-alloy may be used in replacement of the Al or Al-alloy Al-GT.

The present invention can be applied not only to transmissive liquid crystal display panels as described here, but also to transflective or reflective type liquid crystal display panels. In the case of a transflective liquid crystal display, a reflective electrode is formed at an upper or lower side of the counter electrode forming a reflector. Meanwhile, in the case of a reflective type liquid crystal display panel, a reflective electrode is used in replacement of the counter electrode.

Furthermore, the transmissive or the transflective liquid crystal display panel may have a backlight (not shown) on the rear side of the liquid crystal panel. In the case of the reflective type liquid crystal display panel, a front light (not shown to an observer) may be arranged.

Also, the present invention is not limited to a liquid crystal display device, but can be applied to other display devices (e.g., an organic EL display device, etc.) having a coating type insulating film 20 on a conductive layer composed of a Mo or Mo-alloy MO-GT.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A display device comprising a first substrate,
wherein the first substrate includes:
a first conductive layer composed of a Mo or Mo-alloy layer;
a coating type insulating film formed above the first conductive layer; and
a second conductive layer composed of an Al or Al-alloy layer formed on the conductive layer, and
wherein the coating type insulating film is formed on the second conductive layer.

2. A display device comprising a first substrate,
wherein the first substrate includes:
a first conductive layer composed of a Mo or Mo-alloy layer;
a coating type insulating film formed above the first conductive layer; and
a second conductive layer composed of a Ti or Ti-alloy layer formed on the conductive layer, and
wherein the coating type insulating film is formed on the second conductive layer.

3. The display device according to claim 1, wherein the first conductive layer and the second conductive layer are transistor gate electrodes, and the second conductive layer is connected to a wiring layer formed on an upper layer of the coating type insulating film.

4. The display device according to claim 2, wherein the first conductive layer and the second conductive layer are transistor gate electrodes, and the second conductive layer is connected to a wiring layer formed on an upper layer of the coating type insulating film.

5. The display device according to claim 3,
wherein the transistor includes, in a portion of at least one of drain and source regions adjacent to a channel region, a low concentration impurity region having the concentration of introduced impurities lower than that of the drain region and the source region,
wherein the first conductive layer is formed on the channel region and the low concentration impurity region of the transistor, and
wherein the second conductive layer is formed on the first conductive layer which is above the channel region of the transistor.

6. The display device according to claim 4,
wherein the transistor includes, in a portion of at least one of drain and source regions adjacent to a channel region, a low concentration impurity region having the concentration of introduced impurities lower than that of the drain region and the source region,
wherein the first conductive layer is formed on the channel region and the low concentration impurity region of the transistor, and
wherein the second conductive layer is formed on the first conductive layer which is above the channel region of the transistor.

7. The display device according to claim 1, wherein the first conductive layer and the second conductive layer are wiring layers.

8. The display device according to claim 2, wherein the first conductive layer and the second conductive layer are wiring layers.

9. A display device comprising a first substrate,
wherein the first substrate includes:
a first conductive layer composed of a Mo or Mo-alloy layer;
a coating type insulating film formed above the first conductive layer; and
a Mo nitride film formed on the first conductive layer, and
wherein the coating type insulating film is formed on the Mo nitride film.

10. The display device according to claim 9, wherein the first conductive layer is a transistor gate electrode.

11. The display device according to claim 9, wherein the first conductive layer is a wiring layer.

12. The display device according to claim 1, wherein the coating type insulating film is composed of a polysilazane or a polysiloxane.

13. The display device according to claim 2, wherein the coating type insulating film is composed of a polysilazane or a polysiloxane.

14. The display device according to claim 9, wherein the coating type insulating film is composed of a polysilazane or a polysiloxane.

15. The display device according to claim 1, where the display device is a liquid crystal display device having a liquid crystal sandwiched between the first substrate and the second substrate.

16. The display device according to claim 2, where the display device is a liquid crystal display device having a liquid crystal sandwiched between the first substrate and the second substrate.

17. The display device according to claim 9, where the display device is a liquid crystal display device having a liquid crystal sandwiched between the first substrate and the second substrate.
